(19) United States
(12) Patent Application Publication
(10) Pub. No.: US 2021/0221581 A1
(43) Pub. Date: Jul. 22, 2021

(54) CONTAINER ASSEMBLIES AND METHODS OF HEATING AND COOLING CONTENTS THEREOF

(71) Applicant: Purdue Research Foundation, West Lafayette, IN (US)

(72) Inventor: Quinci Danielle Miller, Indianapolis, IN (US)

(21) Appl. No.: 17/154,383

(22) Filed: Jan. 21, 2021

Related U.S. Application Data
(60) Provisional application No. 62/963,823, filed on Jan. 21, 2020.

(51) Int. Cl. B65D 51/28; B65D 53/02; B65D 43/02; B65D 51/24; B65D 81/18; F25D 3/08; A23L 5/10

(52) U.S. Cl. CPC B65D 51/28; B65D 53/02; B65D 43/0208; B65D 51/242; B65D 51/249; A23V 2002/00; F25D 3/08; A23L 5/10; B65D 2543/00194; B65D 2543/00537; B65D 2543/005; B65D 81/18

(57) ABSTRACT

Container assemblies and methods suitable for cooking, transporting, and storing the contents of the container assemblies while maintaining the contents therein at a desired temperature. Such a container assembly includes a container having a lower wall, side walls, and an opening opposite the lower wall that provides access to a cavity within the container. The container assembly further includes a lid configured to releasably attach to the side walls and thereby enclose the cavity to define a storage compartment. A thermal mass is coupled to an interior side of the lid such that at least a portion of the thermal mass faces and is exposed to the storage compartment when the lid is attached to the container. The thermal mass is configured to be heated to an elevated temperature or cooled to a reduced temperature and maintain the elevated or reduced temperature for a period of time.

### CROSS REFERENCE TO RELATED APPLICATIONS

This application claims the benefit of U.S. Provisional Application No. 62/963,823, filed Jan. 21, 2020, the contents of which are incorporated herein by reference.

### BACKGROUND OF THE INVENTION

The present invention generally relates to containers. The invention particularly relates to container assemblies configured to heat and cool contents stored therein for a period of time.

Individuals commonly prepare food at home and then transport the food to another location for consumption, such as another individual's home or an event such as a potluck dinner, sporting event, etc. Food may be prepared in, for example, a baking dish, and then transported in a different container or, in some cases, transported in the same dish by placing a cover over the dish, as examples, a lid or a disposable material such as metal or plastic foil. Foods are often preferably served at a reduced or elevated temperature relative to room temperature, and conventional methods of containment and transportation often fail to adequately maintain preferred food temperatures. Consequently, access to electrical power is often needed or at least desirable to supply power to equipment capable of maintaining a desired temperature for the food during transport, and/or to re-warm or re-chill the food once at the intended destination.

In view of the above, it would be desirable if means and methods were available for sealing and maintaining desired temperatures of food during transport without requiring access to electrical power.

### BRIEF DESCRIPTION OF THE INVENTION

The present invention provides container assemblies and methods suitable for cooking, transporting, and storing the contents of the container assemblies while simultaneously maintaining the contents therein at a desired elevated or reduced temperature.

According to one aspect of the invention, a container assembly is provided that includes a container having a lower wall that defines a base of the container, side walls connected to the lower wall, and an opening opposite the lower wall that provides access to a cavity defined by the lower wall and the side walls. The container assembly further includes a lid configured to releasably attach to the side walls and thereby enclose the cavity to define a storage compartment. A thermal mass is coupled to an interior side of the lid such that at least a portion of the thermal mass faces and is exposed to the storage compartment when the lid is attached to the container. The thermal mass is configured to be heated to an elevated temperature or cooled to a reduced temperature and maintain the elevated or reduced temperature for a period of time.

According to another aspect of the invention, a method of heating or cooling the contents of a container over a period of time uses a container having a lower wall that defines a base of the container, side walls connected to the lower wall, and an opening opposite the lower wall that provides access to a cavity defined by the lower wall and the side walls. A lid is provided that is releasably attached to the side walls of the container and thereby enclose the cavity to define a storage compartment. The method further includes heating or cooling a thermal mass to a predetermined temperature, securing the thermal mass to an interior side of the lid once the thermal mass reaches the predetermined temperature, attaching the lid to the container such that at least a portion of the thermal mass faces and is exposed to the storage compartment, and warming or cooling the contents of the container assembly within the storage compartment with the thermal mass for the period of time.

Technical effects ofthe container assembly and method described above preferably include the ability to maintain an elevated or reduced temperature within the storage compartment ofthe container assembly in order to better maintain the temperature ofcontents within the storage compartment over time without requiring access to electrical power.

Other aspects and advantages of this invention will be appreciated from the following detailed description.

### BRIEF DESCRIPTION OF THE DRAWINGS

FIGS. 1 through 7 represent various aspects of a container assembly in accordance with a first nonlimiting embodiment of the invention.

FIGS. 8A through 8D represent exemplary steps in a method of using the container assembly of FIGS. 1 through 7.

FIGS. 9A and 9B represent a lid for a container assembly in accordance with a nonlimiting aspect of the invention.

FIGS. 10A and 10B represent a thermal mass in a harness in accordance with a nonlimiting aspect of the invention.

### DETAILED DESCRIPTION OF THE INVENTION

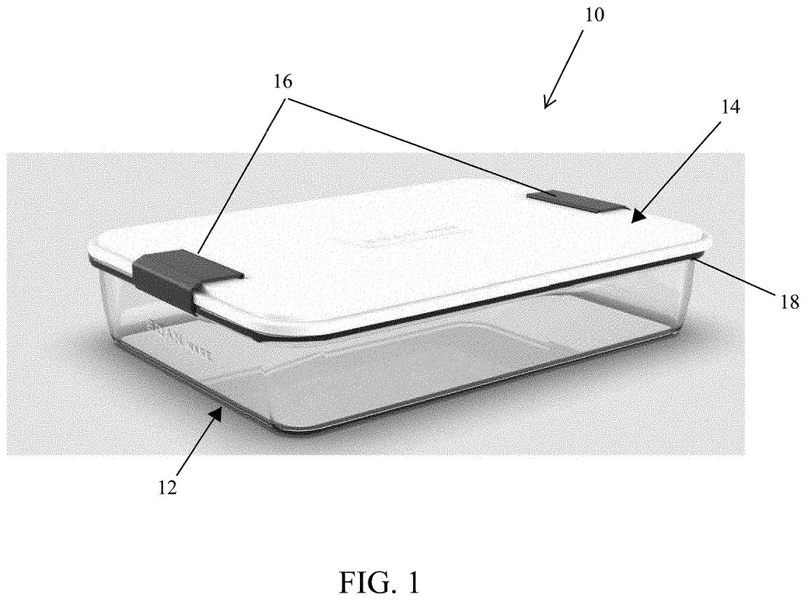

FIGS. 1 through 10B disclose nonlimiting embodiments of a food storage container assembly 10 suitable for use in cooking, transporting, and storing food. In particular, the food storage container assembly 10 is configured to maintain a desired internal temperature specific to a food stored therein.

To facilitate the description provided below of the embodiment represented in the drawings, relative terms, including but not limited to, “side,” “upper,” “lower,” “above,” “below,” etc., may be used in reference to an orientation of the container assembly 10 during its operation, and therefore are relative terms that indicate the construction, installation and use of the invention, but should not be necessarily interpreted as limiting the scope of the invention. Further, although the container assembly 10 is described as adapted for storing food, it is not limited to such and could be used to store and transport various materials.

In a first embodiment represented in FIGS. 1 through 7, the container assembly 10 includes a container 12 and a lid 14, which together define a storage compartment therebetween that is suitable for containing foods or other desired contents. This particular but nonlimiting embodiment of the container 12 has an interior cavity defined by four side walls and a lower or base wall. An upper opening to the container cavity is disposed opposite the base wall and is defined and surrounded by upper edges of the side walls. The container 12 is represented as a standard 9×13 inch (3.5×5.1 cm) glass baking dish, though it should be understood that the container 12 could have various other shapes and dimensions. The container 12 is preferably, though not necessarily, formed of a material capable of being used to prepare, store, cook, warm, and reheat food, for example, in conventional, convection, and microwave ovens. Although not represented, the container 12 may include one or more handles for carrying the container assembly 10.

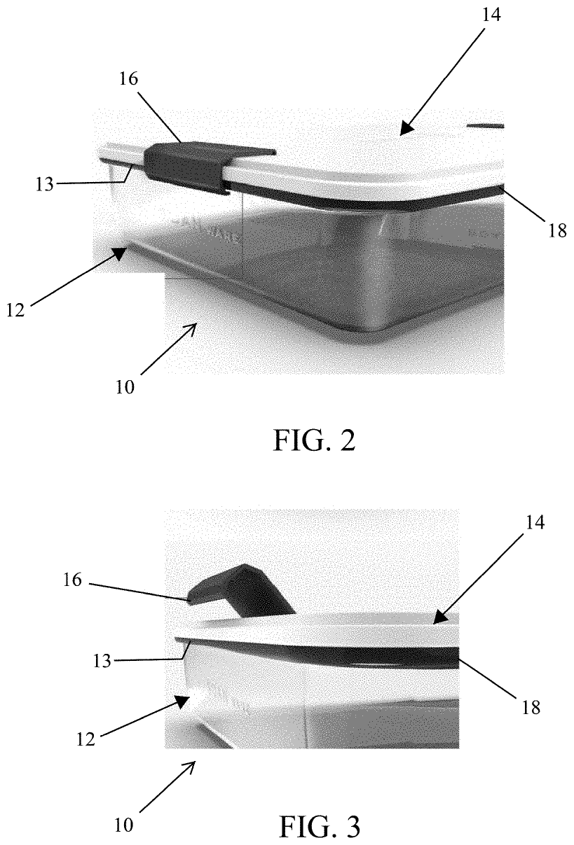

The lid 14 is a generally planar body configured to releasably couple to the upper edges of the side walls of the container 12 so that the lid 14 encloses the cavity defined by the container 12, particularly its side walls and base wall, and an interior side of the lid 14 faces the cavity of the container 12. In this nonlimiting embodiment, the lid 14 is represented as an assembly that comprises a base member 15 primarily on and forming an exterior side of the lid 14, and pivoting clasps 16 on at least two opposite ends of the base member 15 for securing the lid 14 to the container 12 by grasping below a lip 13 along upper edges of the side walls of the container 12 (FIGS. 2 and 3). Once secured to the container 12, the clasps 16 may function as handles for carrying the container 12 or its lid 14, potentially with the ability to thermally protect the user's hands from an elevated or reduced temperature of the container 12. Other methods of securing the lid 14 are foreseeable and within the scope of the invention. For example, edges of the lid 14 may be configured to snap fit to the lip 13 or rim of the container 12. The lid 14 is represented as further including a gasket 18 along edges of the base member 15 to preferably form a liquid-tight seal with the container 12 along upper edges of the side walls of the container 12 when the lid 14 is secured to the container 12. The gasket 18 may be formed of various elastically deformable materials, such as but not limited to silicon rubber materials.

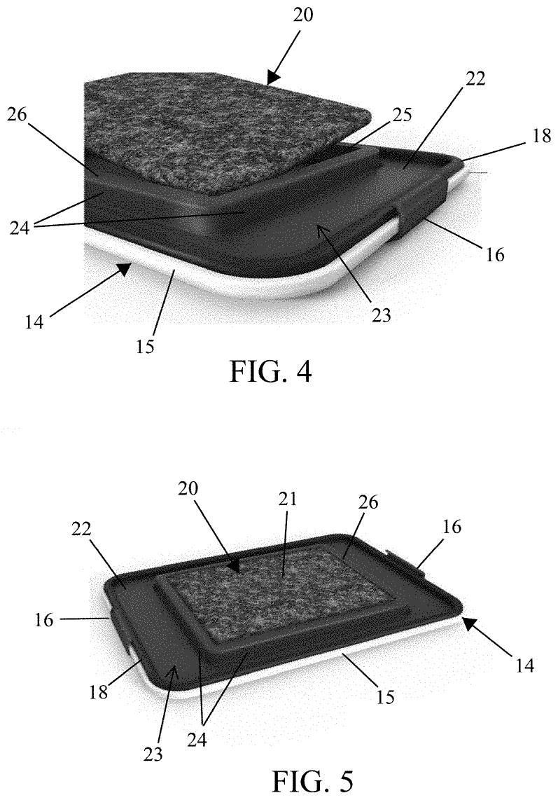

In FIGS. 4 and 5, the lid 14 can be further seen to comprise a lining 23 assembled to the base member 15 and located on the interior side of the lid 14. The lining 23 defines interior walls 24 that protrude from a lower or interior face 22 of the lining 23. In the nonlimiting embodiment shown in FIGS. 1 through 7, the lining 23 and its interior face 22 and walls 24 are defined by portions of a single unitary member attached (for example, bonded) to the base member 15 of the lid 14, though it is foreseeable that the interior face 22 and walls 24 could be integral features of the lid 14 or formed by multiple members separately attached to the lid 14. The interior walls 24 and a portion of the interior face 22 surrounded by the walls 24 define a lid compartment 25 (FIG. 4) that has an opening facing the interior side of the lid 14. The lid compartment 25 is configured to receive and hold therein a thermal mass 20, generally in the form of planar body. As represented in FIG. 5, a portion of the thermal mass 20 is contained and secured within the compartment 25, while at least a surface 21 of the thermal mass 20 is exposed within the opening of the lid compartment 25. FIGS. 4 and 5 represent the interior walls 24 as being complementary in shape and size to the outer perimeter of the thermal mass 20, which has a relatively planar shape that fits snugly between the interior walls 24 of the lid 14. Furthermore, the surface 21 of the thermal mass 20 is represented as substantially flat so as to be roughly parallel to the interior face 22 of the lining 23 when the thermal mass 20 is within the compartment 25. As evident from FIG. 5, the shapes of the thermal mass 20 and the interior walls 24 can be such that the surface 21 of the thermal mass 20 exposed within the opening of the lid compartment 25 may be substantially flush with upper edges of the interior walls 24.

To secure the thermal mass 20, the interior walls 24 comprise one or more elements or projections 26 along their upper edges that extend inward into and/or over the lid compartment 25. In the nonlimiting embodiment shown, the projections 26 are in the form of a continuous lip along the upper edges of the walls 24 so that, when the thermal mass 20 is located in the lid compartment 25, the projections 26 overlap edge portions of the thermal mass 20 that are along the perimeter and on the surface 21 of the thermal mass 20. Preferably, the projections 26 define an interior perimeter of the opening to the compartment 25 that is smaller than the outer perimeter of the thermal mass 20, and the interior walls 24 and/or projections 26 are formed of one or more materials that are sufficiently pliable to elastically deform to allow the interior walls 24 and/or projections 26 to expand outwardly from the compartment 25 and permit the thermal mass 20 to be inserted into the lid compartment 25 and secured therein with the projections 26, as well as completely removed from the compartment 25, as represented in FIG. 4. It will be understood that the interior walls 24, projections 26, and thermal mass 20 may have shapes and sizes other than those represented in the drawings and described herein, as long as they cooperate to permit the thermal mass 20 to be installed in, secured within, and removed from the lid compartment 25.

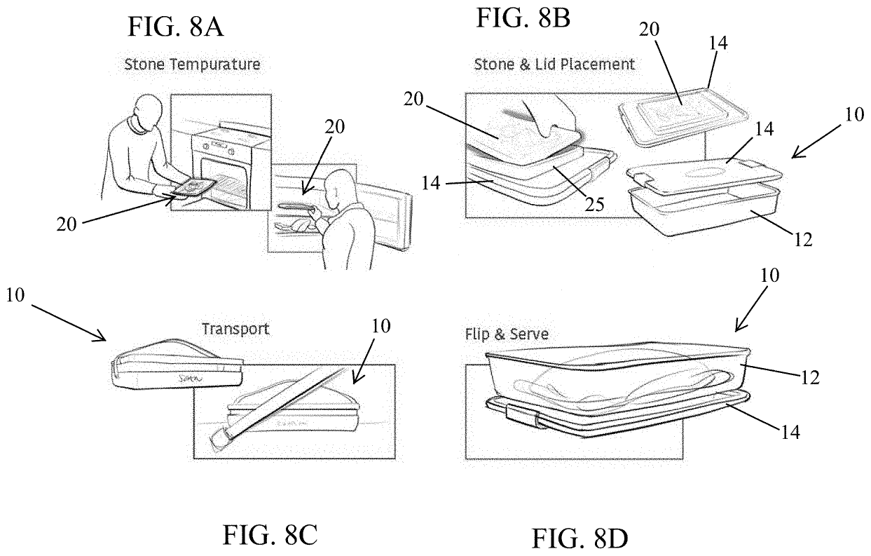

During use of the container assembly 10, food may be prepared in the container 12 or may be prepared in another container and then transferred to the container 12. The thermal mass 20 is preferably preheated or precooled to a desired temperature before being inserted into the lid compartment 25. The lid 14 may then be secured to the container 12 to cover and seal the food within the container assembly 10. While sealed, the thermal mass 20 preferably helps to maintain the internal environment of the container assembly 10, including any food therein, at or near the temperature of the thermal mass 20. Heat transfer between the thermal mass 20 and the interior of the container 12 is promoted by the relatively large portion of the mass 20 that lies beneath its surface 21, which in turn is directly exposed to the interior cavity ofthe container 12. In this manner, a desired or acceptable elevated or reduced temperature relative to the surrounding environment can be maintained for a period of time that is longer than would be possible without the thermal mass 20. This enables the food stored in the container assembly 10 to be kept at a relatively warm or cool (as desired) without access to electrical power. Exemplary steps in this method are represented in FIGS. 8A through 8D.

Since it is desired that the thermal mass 20 maintains an elevated or reduced temperature within the container assembly 10 for an extended period of time, the thermal mass 20 is preferably formed of a material having a relatively high thermal capacitance and has a relatively high mass relative to the container 12 and a relatively high volume relative to the volume of the interior cavity of the container 12. The thermal mass 20 also benefits from having a relatively low thermal conductivity to inhibit heat transfer between the contents within the storage compartment and the exterior side of the lid 14. For this purpose, preferred materials for the thermal mass 20 include synthetic and naturally occurring rock and ceramic materials. Suitable but nonlimiting materials include soapstone, granite, gypsum, basalt, marble, limestone, sandstone, or firebrick.

As noted above, the thermal mass 20 should have a sufficient mass relative to the size (volume or area) of the container 12 in order to keep the contents of the container 12 at a desired temperature over a targeted period of time. As a nonlimiting example, the thermal mass 20 may be approximately 60 to 70 percent of the overall width/length/height of the lid 14. Relative to the container 12, the thermal mass 20 may be about 12.5 to 15 percent of the depth of the container 12. For the 9×13 inch baking dish represented in the drawings, the thermal mass 20 is preferably between 0.3 to 0.5 inches (0.1 to 0.2 cm) in thickness. Although the thermal mass 20 is represented as having smooth surfaces in the drawings, it could alternatively include surface features configured to modify thermal transfer, such as ridges or recesses on its surface 21.

The lid 14, its components, and the thermal mass 20, may be formed of materials capable of being maintained and used in a wide range of temperatures both above and below room temperature. In one nonlimiting embodiment, the thermal mass 20 is a slab of soapstone, the base member 15 of the lid 14 is formed of a relatively rigid plastic such as polypropylene, and the lining 23 attached to the base member 15 or at least its interior face 22 and walls 24 is formed of an elastic material such as silicone. The lining 23 preferably serves as a thermal barrier lining for the assembly 10, and for this purpose the lining 23 covers most if not all portions of the lid 14 that are on the interior side of the lid 14 and therefore within and facing the interior cavity of the container 12 when the lid 14 is installed on the container 12. By also covering the base member 15 within the lid compartment 25, the lining 23 also provides a thermal barrier between the thermal mass 20 and the exterior side of the lid 14. When the lid 14 is secured to the container 12, the gasket 18 and the lining 23 act to thermally and fluidically seal the storage compartment of the assembly 10 formed at least in part by the cavity of the container 12. In such an embodiment, the thermal mass 20 may have a mass of approximately 400 to 500 grams with a volume of about 400 to 500 cubic centimeters.

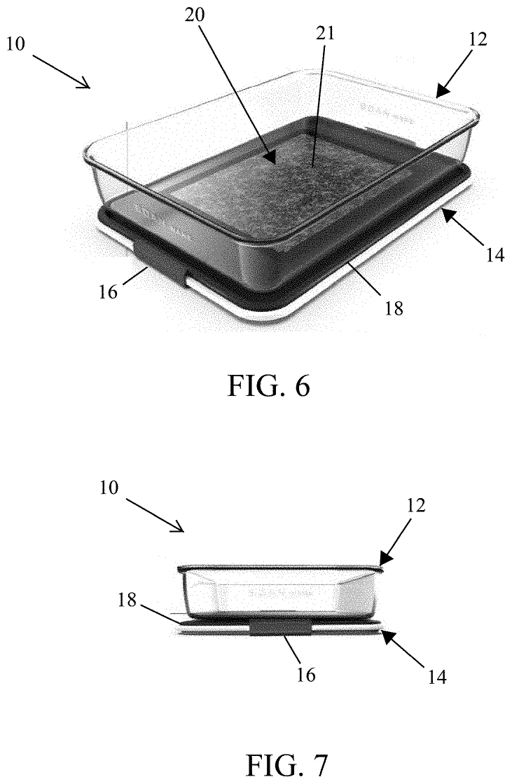

In addition to maintaining reduced or elevated temperatures within the sealed container assembly 10, the lid 14 and thermal mass 20 may be used to maintain desired temperatures while food is being served. For example, FIGS. 6, 7, and 8D depict the lid 14 as detached from the container 12, such that the lid 14 can be placed on a support surface (such as a counter or table) with the exterior side of the lid 14 facing the support surface and the interior side of the lid 14 facing upward so that the surface 21 of the thermal mass 20 also faces upward and away from the support surface. The surface 21 of the thermal mass 20 can then be used to support the container 12. Heat transfer between the container 12 and the thermal mass 20 can be promoted if the surface 21 of the thermal mass 20 exposed within the opening of the lid compartment 25 is substantially flush with the upper edges of the interior walls 24 that form the compartment 25, or the surface 21 projects slightly above the interior walls 24, for example, due to the surface 21 of the thermal mass 20 being slightly convex. With this arrangement, the thermal mass 20 may continue to warm or cool the food while it is served or displayed. It is also foreseeable that the thermal mass 20, alone or assembled with the lid 14, may be used as a serving dish at room temperature.

In view of the above, the container assembly 10 is suitable for use in cooking, transporting, and storing food, and may be particularly useful for foods that are intended to be cooked at a first location and transported to a second location for consumption. For example, an individual could bake food in the container 12 in an oven at home and separately or simultaneously heat the thermal mass 20 in the oven. Once heated, the thermal mass 20 may be assembled with the lid 14 (i.e., secured in the lid compartment 25) and then the lid 14 secured to the container 12 to enclose and seal the cooked food within the cavity of the container 12. As the user transports the container assembly 10 to another location, the container assembly 10 helps to maintain the food at an elevated temperature. Once it is time to serve the food, the lid 14 may be placed on a table with the lid 14 upside-down such that the thermal mass 20 is facing upward, and the container 12 may be placed on the lid 14 so that the thermal mass 20 continues to warm the food within the container 12 from underneath. As an alternative to the above example, the thermal mass 20 may be cooled in a freezer and subsequently used to maintain a reduced temperature within the container assembly 10. As such, the container assembly 10 provides for the ability to warm or cool its contents for a period of time without use of electricity (after the thermal mass 20 is initially heated or cooled).

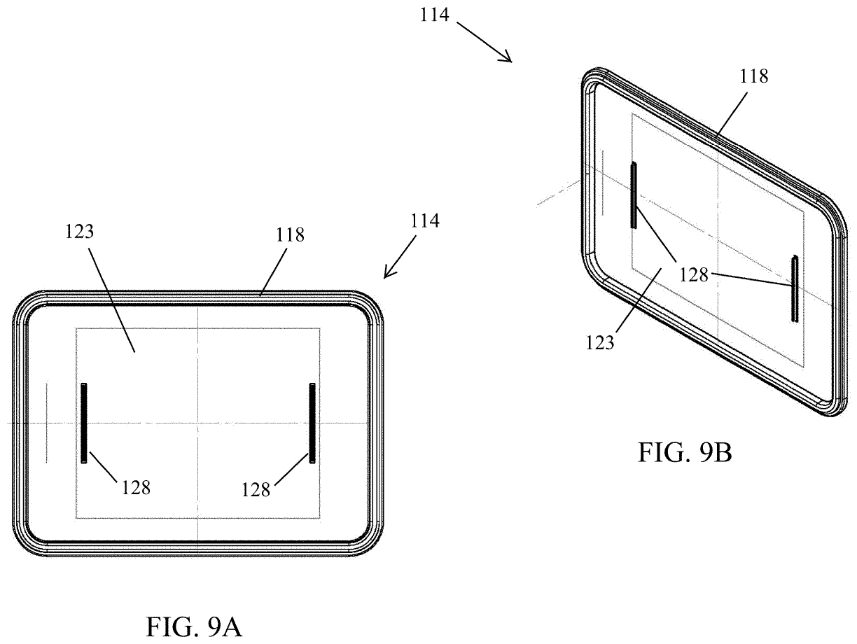

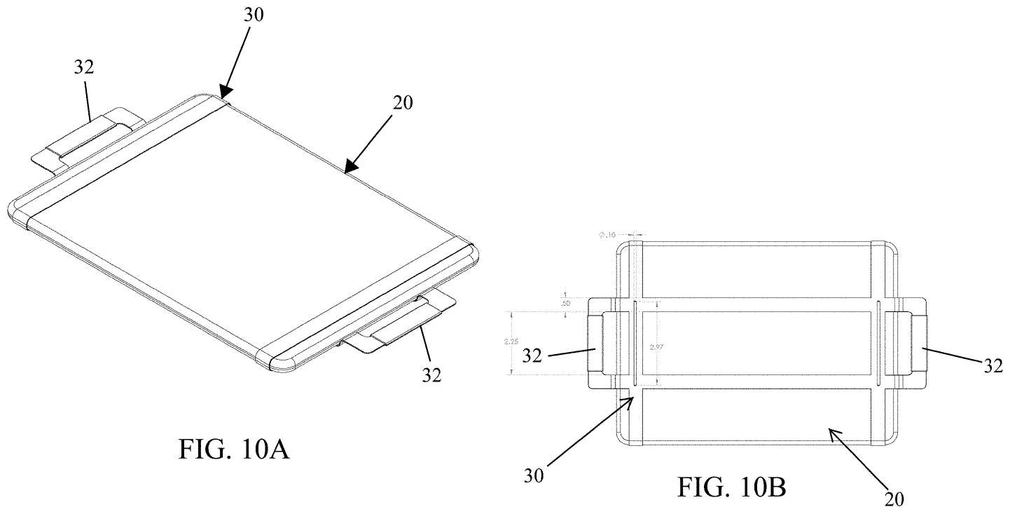

FIGS. 9A and 9B represent an alternative embodiment of a lid 114, as well as an alternative method of attaching a thermal mass 120 with a harness 30 shown in FIGS. 10A and 10B. In view of similarities between the embodiments shown in the drawings, the following discussion of FIGS. 9A through 10B will focus primarily on aspects of the alternative embodiment that differ from the embodiment of FIGS. 1 through 7 in some notable or significant manner Other aspects of the further embodiments not discussed in any detail can be, in terms of structure, function, materials, etc., essentially as was described for the first embodiment. In FIGS. 9A through 10B, consistent reference numbers are used to identify certain elements that have substantially the same function as an element shown in FIGS. 1 through 7, but with the numerical prefix “1” added.

In the embodiment ofFIGS. 9A through 10B, the thermal mass 120 is not secured to the interior side of the lid 114 with a compartment defined on the interior side of the lid 114. Instead, the thermal mass 120 may be secured in a harness 30 as represented in FIGS. 10A and 10B, and then the harness 30 may be secured to the interior side of the lid 114. For example, handles 32 of the harness 30 may be configured to mate with brackets 128 formed by a lining 123 on the interior side of the lid 114 in a snap-fit manner

While the invention has been described in terms of specific or particular embodiments, it should be apparent that alternatives could be adopted by one skilled in the art. For example, the container assembly 10 and its components could differ in appearance and construction from the embodiment described herein and shown in the drawings, functions of certain components of the container assembly 10 could be performed by components of different construction but capable of a similar (though not necessarily equivalent) function, and appropriate materials could be substituted for those noted. Accordingly, it should be understood that the invention is not necessarily limited to any embodiment described herein or illustrated in the drawings. It should also be understood that the phraseology and terminology employed above are for the purpose of describing the disclosed embodiment, and do not necessarily serve as limitations to the scope of the invention. Therefore, the scope of the invention is to be limited only by the following claims.

1. A container assembly comprising:
a container having a lower wall that defines a base of the container, side walls connected to the lower wall, and an opening opposite the lower wall that provides access to a cavity defined by the lower wall and the side walls;
a lid releasably attached to the side walls to thereby enclose the cavity and define therewith a storage compartment; and
a thermal mass removably coupled to an interior side of the lid such that at least a portion of the thermal mass faces and is exposed to the storage compartment when the lid is attached to the container, wherein the thermal mass is capable of being heated to an elevated temperature and cooled to a reduced temperature.

2. The container assembly ofclaim 1, further comprising a gasket located adjacent edges of the lid on the interior side thereof and configured to seal the storage compartment between the lid and the container.

3. The container assembly of claim 1, further comprising clasps configured to secure the lid to the container by grasping a lip along edges of the side walls.

4. The container assembly of claim 3, wherein the clasps are handles for carrying the container assembly when the lid is attached to the container.

5. The container assembly ofclaim 1, wherein the container assembly is configured such that, when the lid and the container are not attached to one another, the lid is able to be located on a support surface with the interior side thereof and an exposed portion of the thermal mass assembled therewith facing away from the support surface and the container is able to be located on the lid such that the lower wall of the container is warmed or cooled by the thermal mass.

6. The container assembly of claim 1, wherein the thermal mass is a slab of stone or ceramic material.

7. The container assembly of claim 1, further comprising interior walls protruding from the interior side of the lid, the interior walls define a lid compartment with an opening exposed at the interior side of the lid, the interior walls receive and retain the thermal mass within the lid compartment, and a surface of the portion of the thermal mass is exposed within the opening of the lid compartment.

8. The container assembly of claim 7, wherein the lid compartment is defined by a thermal barrier lining on the interior side of the lid.

9. The container assembly of claim 7, wherein the interior walls have one or more projections extending over the lid compartment and overlapping edges of the thermal mass within the lid compartment, and the interior walls and the projections are pliable to allow the thermal mass to be inserted into and removed from the lid compartment.

10. The container assembly of claim 7, wherein the surface of the portion of the thermal mass exposed within the opening of the lid compartment is flush with upper edges of the interior walls.

11. The container assembly of claim 1, further comprising a harness secured to the thermal mass and removably coupled to the interior side of the lid.

12. A method of heating or cooling contents of a container over a period of time, the method comprising:
providing a container having a lower wall that defines a base of the container, side walls connected to the lower wall, and an opening opposite the lower wall that provides access to a cavity defined by the lower wall and the side walls;
providing a lid releasably attached to the side walls of the container to enclose the cavity and define therewith a storage compartment;
heating or cooling a thermal mass to a predetermined temperature;
securing the thermal mass to an interior side of the lid once the thermal mass reaches the predetermined temperature;
attaching the lid to the container such that at least a portion of the thermal mass faces and is exposed to the storage compartment; and
warming or cooling the contents of the container assembly within the storage compartment with the thermal mass for the period of time.

13. The method of claim 12, further comprising fluidically sealing the storage compartment with a gasket located adjacent edges of the lid on the interior side thereof

14. The method of claim 12, wherein the lid is attached to the container with clasps on the lid that grasp a lip along edges of the side walls.

15. The method of claim 14, further comprising transporting the container assembly while using the clasps as handles after attaching the lid to the container.

16. The method of claim 12, further comprising:
detaching the lid from the container;
locating the lid on a support surface with the interior side thereof and an exposed portion of the thermal mass assembled therewith facing away from the support surface; and
locating the container on the lid such that the lower wall of the container is warmed or cooled by the thermal mass.

17. The method of claim 12, wherein the contents of the container are foods and the method further comprises cooking the foods in the container.

18. The method of claim 12, wherein the lid includes interior walls protruding from the interior side of the lid to define a lid compartment with an opening facing the interior side of the lid, and the method comprises securing the thermal mass to the lid by locating the thermal mass within the lid compartment and between the interior walls.

19. The method of claim 18, wherein the method comprises securing the thermal mass to the interior side of the lid by locating the thermal mass within the lid compartment and between projections extending from edges of the interior walls over the lid compartment such that the projections overlap edges of the thermal mass, the method further comprising elastically deforming the interior walls and the projections to allow the thermal mass to be inserted into the lid compartment.

20. The method of claim 12, further comprising securing the thermal mass in a harness and then securing the thermal mass to the lid by coupling the harness to brackets located on the interior side of the lid.
